(19) United States
(12) Patent Application Publication
(10) Pub. No.: US 2026/0031251 A1
(43) Pub. Date: Jan. 29, 2026

(54) CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: YU GONG, Huaian (CN); A-Nan Yang, Huaian (CN); Han-Run Xie, Huaian (CN); Lu-Yu Chang, New Taipei (TW)

(21) Appl. No.: 19/277,793

(22) Filed: Jul. 23, 2025

(30) Foreign Application Priority Data
Jul. 25, 2024 (CN) 202421766213.0

(51) Int. Cl. H01B 7/08; H01B 7/02

(52) U.S. Cl. CPC H01B 7/0823; H01B 7/0216; H01B 7/0275

(57) ABSTRACT

A cable includes: plural core wire groups sequentially arranged in a transverse direction and each including a pair of inner conductors and an inner insulating layer covering the pair of inner conductors; and a shielding layer covering the plurality of core wire groups, wherein the shielding layer has an upper part and a lower part covering the core wire groups, and the inner insulating layer includes a first insulating layer covering the pair of inner conductors and a second insulating layer covering the first insulating layer.

### BACKGROUND OF THE INVENTION

### Field of the Invention

The present invention relates generally to a cable, and more particularly to a cable capable of being integrally connected in subsequent assembly.

### Description of Related Arts

With the development and popularization of electronic technology products, cables are widely used in household appliances, instrumentation, automation equipment, data centers, servers, switches, cloud computing and 5G as a tool for signal transmission. However, during signal transmission process, the cable is susceptible to interference from external electromagnetic signals so it is often necessary to use a shielding structure to eliminate or reduce the interference of the external electromagnetic field and to prevent the leakage of the transmission signal. Usually, a single high-speed transmission signal wire is wrapped or longitudinally covered with a metal shielding tape on the core surface.

CN Patent No. 212434276 discloses a cable comprising a pair of parallel core wires, a first shielding tape wrapped around the pair of core wires, and a second shielding tape wrapped around the first shielding tape. The first shielding tape is wrapped around the pair of core wires in a longitudinal manner, and the second shielding tape is wrapped around the first shielding tape in a winding manner. The gaps at the junctions of the shielding tape will affect the cable's ability to resist electromagnetic interference. The shielding layer of each cable needs to be soldered to the corresponding contact parts of component respectively, and the assembly and soldering process is complicated.

Therefore, it is desired to provide a cable with good electrical performance and easy to assemble and solder.

### SUMMARY OF THE INVENTION

A main object of the present invention is to provide a cable with good shielding effect and easy to assemble and solder.

To achieve the above object, a cable includes: a plurality of core wire groups sequentially arranged in a transverse direction and each including: a pair of inner conductors; and an inner insulating layer covering the pair of inner conductors; and a shielding layer covering the plurality of core wire groups, wherein the shielding layer has an upper part and a lower part covering the plurality of core wire groups, and the inner insulating layer includes a first insulating layer covering the pair of inner conductors and a second insulating layer covering the first insulating layer.

Compared to prior art, in the present invention, the shielding layer covers the core wire groups from the upper and lower sides, and fixes the the core wire groups into a row along the transverse direction, which not only has better electrical performance, but also facilitates the overall assembly and soldering of the cable, thus greatly improving the production efficiency.

### BRIEF DESCRIPTION OF THE DRAWING

FIG. 1 is a cross-sectional view of a first embodiment of a cable of the present invention;

FIG. 2 is a cross-sectional view of a second embodiment of a cable of the present invention;

FIG. 3 is a cross-sectional view of a third embodiment of a cable of the present invention;

FIG. 4 is a cross-sectional view of a fourth embodiment of a cable of the present invention;

FIG. 5 is a cross-sectional view of a fifth embodiment of a cable of the present invention;

FIG. 6 is a cross-sectional view of the core wire of the cable in FIG. 5;

FIG. 7 is a cross-sectional view of a sixth embodiment of a cable of the present invention; and

FIG. 8 is a cross-sectional view of the core wire of the cable in FIG. 7.

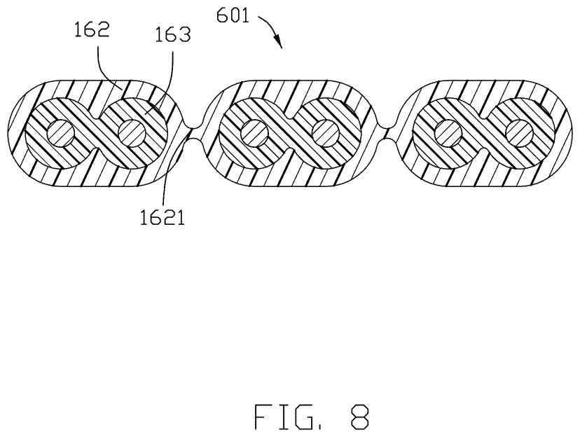

### DETAILED DESCRIPTION OF THE PREFERRED EMBODIMENT

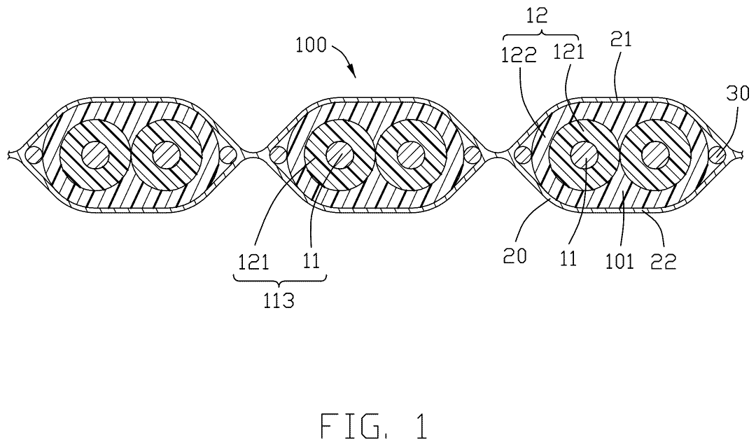

Referring to FIG. 1, the first embodiment of the cable 100 of the present invention is shown. The cable 100 includes a plurality of core wire groups 101 and a shielding layer 20 covering the plurality of core wire groups 101. The plurality of core wire groups 101 are arranged along the transverse direction. The shielding layer 20 covers the core wire group 101 from two sides in the up and down directions perpendicular to the transverse direction to fix the plurality of core wire groups 101 in a row along the transverse direction and provide shielding between adjacent core wire groups 101.

Each of the core wire groups 101 is independent, and a gap is reserved between two adjacent core wire groups 101. Each of the core wire groups 101 includes a pair of inner conductors 11 and an inner insulating layer 12 covering the inner conductors 11. The inner conductor 11 is used to transmit high-speed signals. The inner conductor 11 is a silver-plated copper inner conductor 11. The inner insulating layer 12 includes a first insulating layer 121 covering the corresponding inner conductor 11, and a second insulating layer 122 covering the first insulating layer 121. The first insulating layer 121 has two parts, each covering a corresponding one of the pair of inner conductors 11 by extrusion molding to form a pair of inner core wires 113. The cross-sectional shape of the each part of the first insulating layer 121 is circular, and the pair of inner core wires 113 are arranged side by side in the transverse direction and contact each other. The second insulating layer 122 covers the pair of inner core wires 113 by extrusion molding. In this way, the relative positions of the two inner conductors 11 are fixed. There is no air gap between the second insulating layer 122 and the pair of inner core wires 113. The cross-section of the second insulating layer 122 is semicircular on two sides in the transverse direction. The cable 100 further includes a pair of bare ground wires 30 disposed on both sides of each core wire group 101 in the transverse direction. Each of the core wire groups 101 can transmit a pair of differential signals. The bare ground wire 30 is in mechanical and electrical contact with the shielding layer 20 on both the upper and lower sides. In other embodiments, only one bare ground wire 30 may be provided, and the number of the core wire group 101 can be increased or decreased as needed.

The shielding layer 20 includes two parts, an upper part and a lower part. The upper part 21 and the lower part 22 are both heat-adhesive metal shielding tapes, and the upper and lower parts are laminated to form the shielding layer 20. The upper part 21 and the lower part 22 are bonded together in the gap between two adjacent core wire groups 101. The shielding layer 20 covers the upper and lower surfaces of the core wire groups 101 by laminating, which greatly reduces the shielding gap and improves the anti-electromagnetic interference ability. At the same time, it can also reduce the problem of unstable electrical characteristics of the cable caused by tension fluctuations of the wrapping machine during the traditional wrapping process of the shielding tape. In the present invention, the shielding layer 20 can not only shield interference but also fix each of the core wire groups 101. Compared with the cumbersome steps of traditional high-speed laminated flat cables, which first wrap the shielding tape and then attach the thermal adhesive Mylar on two sides, the structure of the present invention can be formed in one step, which greatly improves the production efficiency, and the present invention omits the outer Mylar, making the cable smaller in size and lower in cost.

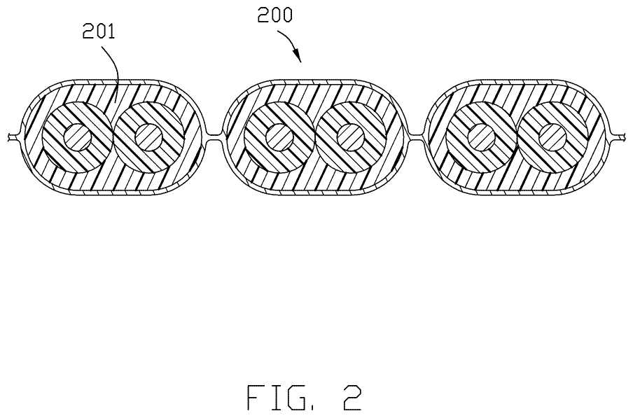

FIG. 2 shows the second embodiment of a cable 200 of the present invention. Compared with the cable 100 of the first embodiment, in this embodiment, there is no bare ground wire on both sides of the core wire group 201.

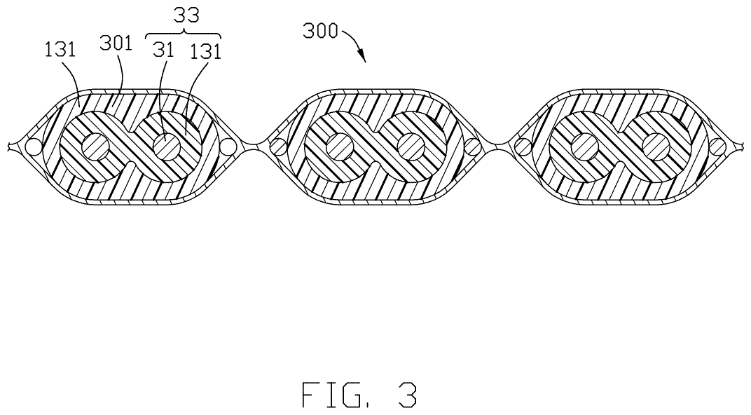

FIG. 3 shows the third embodiment of a cable 300 of the present invention. Compared with the cable 100 of the first embodiment, in this embodiment, there is no bare ground wire on both sides of the core wire group 201. The first insulating layer 131 of each core wire group 301 is extruded over a pair of inner conductors and includes a connecting portion located between the pair of inner conductors to form an eight-shaped inner core wire 133, and the second insulating layer 132 is extruded outside the first insulating layer 131.

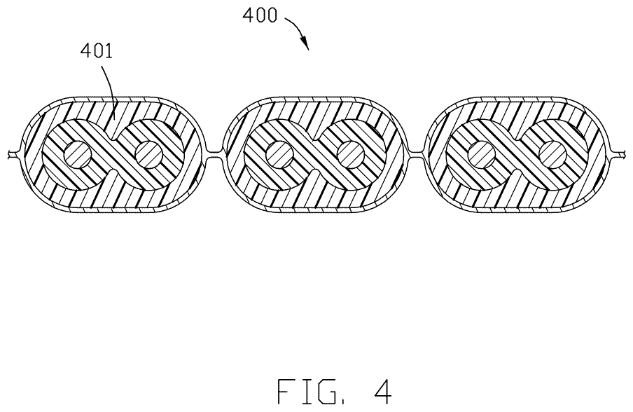

FIG. 4 shows the fourth embodiment of a cable 400 of the present invention. Compared with the cable 300 of the third embodiment, in this embodiment, there is no bare ground wire on both sides of the core wire group 401.

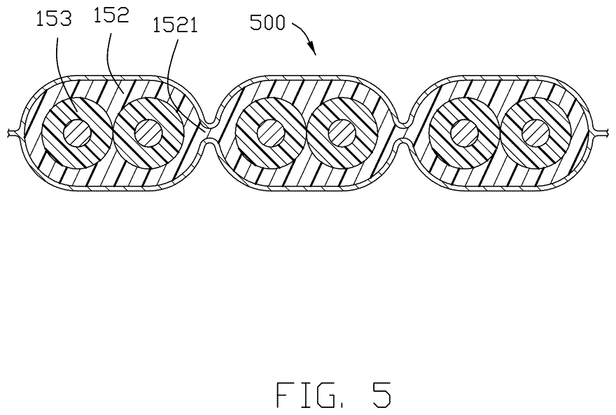

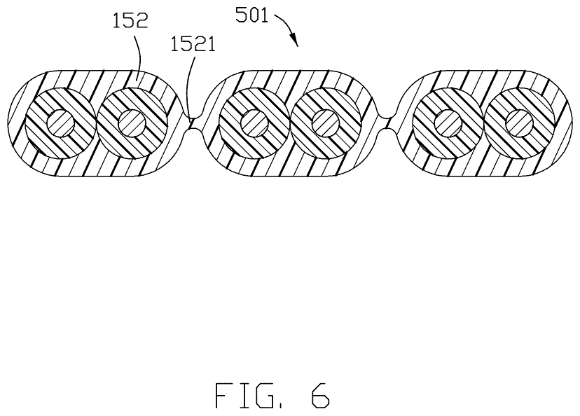

FIG. 5 shows the fourth embodiment of a cable 500 of the present invention. Compared with the cable 200 of the second embodiment, in this embodiment, the second insulating layer 152 is extruded over the pair of inner core wires 153. The core wire groups 501 are fixed in the transverse direction through the second insulating layer 152. The second insulating layers 152 include a connecting portion 1521 between adjacent core wire groups 501, and the size of the connecting portion 1521 in the vertical direction is smaller than the size of the thinnest part of the second insulating layer 152. FIG. 6 shows a cross-sectional view of the core wire groups 501 of the cable of the fifth embodiment.

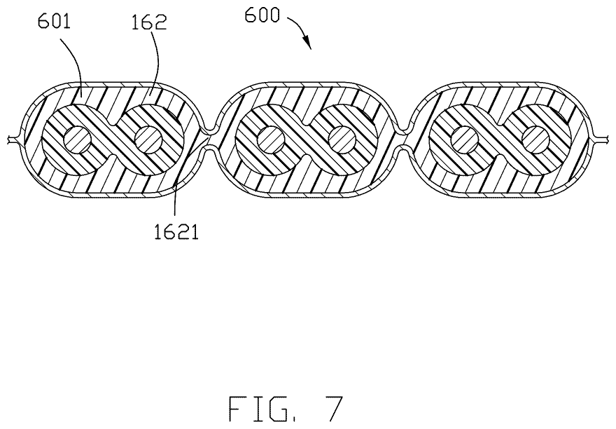

FIG. 7 shows the sixth embodiment of a cable 600 of the present invention. Compared with the cable 400 of the fourth embodiment, in this embodiment, the core wire groups 601 are fixed together in the transverse direction through the second insulating layer 162. The second insulating layer 162 includes a connecting portion 1621 between adjacent core wire groups 601. FIG. 6 shows a cross-sectional view of the core wire groups 601 of the cable of the sixth embodiment.

In the present invention, the inner insulating layer 12 of the cable includes a first insulating layer 121 covering the corresponding inner conductor and a second insulating layer 122 covering the first insulating layer 121. In addition, the shielding layer 30 is attached to the core wire groups 10 from the upper and lower sides to arrange the core wire groups in a row along the transverse direction, which not only has better electrical performance, but also facilitates the overall assembly and soldering of the cable, greatly improving production efficiency, and the outer layer of Mylar can be omitted, making the cable size smaller and the cost lower.

1. A cable comprising:
a plurality of core wire groups sequentially arranged in a transverse direction and each comprising:
a pair of inner conductors; and
an inner insulating layer covering the pair of inner conductors; and
a shielding layer covering the plurality of core wire groups, wherein
the shielding layer has an upper part and a lower part covering the plurality of core wire groups, and the inner insulating layer includes a first insulating layer covering the pair of inner conductors and a second insulating layer covering the first insulating layer.

2. The cable as claimed in claim 1, wherein the first insulating layer has two parts covering the pair of inner conductors to form a pair of inner core wires, and the second insulating layer is extruded over the pair of inner core wires.

3. The cable as claimed in claim 2, wherein the cross-sectional shape of the second insulating layer is semicircular on two sides thereof in the transverse direction, and the cross-sectional shape of each of the two parts of the first insulating layer is circular.

4. The cable as claimed in claim 3, wherein the two parts of the first insulating layer are in contact with each other.

5. The cable as claimed in claim 2, wherein the plurality of core wire groups are fixed in the transverse direction by the second insulating layer.

6. The cable as claimed in claim 1, wherein each of the core wire groups is individually held by the shielding layer, and two adjacent core wire groups are separated by the shielding layer.

7. The cable as claimed in claim 1, further comprising a pair of ground wires respectively located on two sides of each core wire group in the transverse direction.

8. The cable as claimed in claim 7, wherein each of the pair of ground wires is in mechanical and electrical contact with the upper part and the lower part of the shielding layer.

9. The cable as claimed in claim 1, wherein the first insulating layer is extruded over the pair of inner conductors and includes a connecting portion located between the pair of inner conductors.

10. The cable as claimed in claim 1, wherein each inner conductor is made of silver-plated copper.
